(19) United States
(12) Patent Application Publication
(10) Pub. No.: US 2022/0384885 A1
(43) Pub. Date: Dec. 1, 2022

(54) BATTERY AND ELECTRONIC DEVICE

(71) Applicant: Ningde Amperex Technology Limited, Ningde City (CN)

(72) Inventors: Dongyang Yan, Ningde City (CN); Fei Wu, Ningde City (CN); Qiao Zeng, Ningde City (CN)

(73) Assignee: Ningde Amperex Technology Limited, Ningde City (CN)

(21) Appl. No.: 17/708,325

(22) Filed: Mar. 30, 2022

(30) Foreign Application Priority Data
May 31, 2021 (CN) 202110602355.8

(51) Int. Cl. H01M 50/186; H01M 50/191; H01M 50/586; H01M 50/184

(52) U.S. Cl. CPC H01M 50/186; H01M 50/191; H01M 50/586; H01M 50/184; H01M 2220/30

(57) ABSTRACT

A battery includes a conductive piece, an electrode assembly, and a housing including a first wall provided with an opening, a second wall disposed opposite to the first wall along a first direction, and a sidewall. An accommodation cavity accommodating the electrode assembly is formed between the first wall, the second wall, and the sidewall. In the first direction, a projection of the conductive piece is at least partly located in a region of a projection of the opening. The battery further includes a sealing structure disposed at an end of the first wall towards the conductive piece and connected to the first wall and an insulation piece disposed between the sealing structure and the conductive piece. A thermal expansion coefficient of at least one of the sealing structure or the conductive piece is greater than a thermal expansion coefficient of the insulation piece.

### CROSS REFERENCE TO RELATED APPLICATION

This application claims priority to the Chinese Patent Application Ser. No. 202110602355.8, filed on May 31, 2021, the content of which is incorporated herein by reference in its entirety.

### TECHNICAL FIELD

This application relates to the field of electric power storage structures, and in particular, to a battery and an electronic device.

### BACKGROUND

Rechargeable secondary button batteries are mostly used in small portable devices. Such devices require a high rate of space utilization. Such a battery needs to contain an electrolytic solution hermetically. In a case that airtightness for the electrolytic solution is good, a high pressure is prone to be formed in the battery under a high temperature condition. The battery under a high pressure is at risk of explosion. Therefore, high requirements are posed on the airtightness and high-temperature reliability of the battery.

### SUMMARY

In view of the problems in the prior art, it is necessary to provide a battery and an electronic device to balance both sealing and explosion-proof problems of the battery concurrently.

An embodiment of this application provides a battery. The battery includes a conductive piece, an electrode assembly, and a housing. The housing includes a first wall, a second wall, and a sidewall that are connected to the first wall and the second wall respectively. The first wall and the second wall are disposed opposite to each other along a first direction. An accommodation cavity is formed between the first wall, the second wall, and the sidewall. The electrode assembly is disposed in the accommodation cavity. The first wall is provided with an opening. In the first direction, a projection of the conductive piece is at least partly located in a region of a projection of the opening. The battery further includes a sealing structure and an insulation piece. The sealing structure is disposed at an end of the first wall towards the conductive piece. The sealing structure is connected to the first wall. The insulation piece is disposed between the sealing structure and the conductive piece. A thermal expansion coefficient of at least one of the sealing structure or the conductive piece is greater than a thermal expansion coefficient of the insulation piece.

When the battery is in normal use, the sealing structure contacts the insulation piece, and coordinates with the conductive piece to seal the opening. In this way, the electrolytic solution in the battery may be maintained in the accommodation cavity, and the battery may work normally. When the battery is under an exceptionally high temperature, because the thermal expansion coefficient of at least one of the sealing structure or the conductive piece is greater than the thermal expansion coefficient of the insulation piece, at least one of the sealing structure or the conductive piece expands rapidly to squeeze and crack the insulation piece. A high-temperature fluid in the accommodation cavity flows out of the accommodation cavity through the crack of the insulation piece to relieve the pressure in the accommodation cavity, thereby reducing the risk of explosion of the battery.

In some embodiments of this application, the sealing structure and the first wall are integrated.

In some embodiments of this application, the sealing structure includes a fitting section and a transition section. The fitting section contacts the insulation piece. The transition section connects the fitting section and the first wall. As viewed along a direction perpendicular to the first direction, the fitting section and the transition section extend in the following directions: from a perspective that approaches the insulation piece from far off the insulation piece, the transition section extends away from the electrode assembly, and the fitting section extends toward the electrode assembly; or, from a perspective that approaches the insulation piece from far off the insulation piece, the transition section extends toward the electrode assembly, and the fitting section extends away from the electrode assembly.

The fitting section is connected to the first wall by the transition section to provide an elastic thrust force for the transition section. The elastic thrust force enables the fitting section to elastically contact the insulation piece, thereby ensuring airtightness at the outer periphery of the insulation piece after the insulation piece is loaded into the opening. In addition, as the temperature rises, the transition section stretches to strengthen the elastic force. In this way, the fitting section exerts a greater pressure on the insulation piece, making it easier to crack the insulation piece.

In some embodiments of this application, the transition section includes a first sub-section and a second sub-section. The first sub-section extends from the first wall and away from the electrode assembly. The second sub-section extends from the first sub-section to the insulation piece. The fitting section is disposed at an end of the second sub-section towards the insulation piece.

The transition segment is divided into two sub-sections that extend in different directions, so that the fitting section, the first sub-section, and the second sub-section form an arcuate structure. When the insulation piece is loaded on the housing, an elastic force may be provided by compressing the second sub-section.

In some embodiments of this application, an angle between the first sub-section and the first wall is 85° to 175°.

The angle between the first sub-section and the first wall is controlled to be within such a range, so that the pressure perpendicular to the first direction may be maintained advantageously when the battery is working normally, thereby achieving good effects of airtightness.

In some embodiments of this application, an angle between the first sub-section and the second sub-section is 85° to 175°.

The angle between the first sub-section and the second sub-section is controlled to be within such a range, so that the pressure perpendicular to the first direction may be maintained advantageously when the battery is working normally, thereby achieving good effects of airtightness.

In some embodiments of this application, the second sub-section is in an arc shape protruding from the accommodation cavity.

The second sub-section designed as an arc-shape, on the one hand, reduces stress concentration of the sealing structure to increase the strength of the sealing structure, and, on the other hand, enables the second sub-section to provide a greater elastic force so that the fitting section fits outside the insulation piece.

In some embodiments of this application, the second sub-section is wave-shaped when viewed along a direction perpendicular to the first direction.

The second sub-section designed as a wave shape may increase the actual length of the second sub-section. Therefore, when the temperature of the battery is high, the second sub-section provides a greater elastic force, so that the insulation piece is more prone to crack under compression. On the other hand, when the extrusion force required under high temperature conditions is the same, the wave-shaped second sub- section is shorter in size in the direction perpendicular to the first direction, and may maximally avoid an excessive extension length of the second sub-section that affects the welding and fixing between the first wall and the sidewall of the housing.

In some embodiments of this application, the fitting section extends from the second sub-section to the electrode assembly, and the angle between the fitting section and the second sub-section is 80° to 100°.

Because the second sub-section extends, as far as possible, along the direction perpendicular to the first direction, in order to make the fitting section fit the outer periphery of the insulation piece as far as possible, the fitting section is arranged to extend along the first direction as far as possible. In this case, the angle between the fitting section and the second sub-section is 80° to 100°.

In some embodiments of this application, the fitting section extends from the second sub-section to the accommodation cavity, and an inset is disposed in the fitting section. The inset is inserted into the insulation piece.

The inset is disposed in the fitting section, and the inset is inserted into the insulation piece to further prevent the fitting section from detaching from the insulation piece, thereby further improving the performance of airtightness between the sealing structure and the insulation piece.

In some embodiments of this application, when viewed in a direction perpendicular to the first direction, a saw-toothed first connecting portion is disposed on an outer periphery of the conductive piece. The insulation piece is provided with a second connecting portion in contact with the first connecting portion.

The saw-toothed first connecting portion coordinates with the second connecting portion to make the conductive piece fit the insulation piece more closely, thereby avoiding existence of a gap between the conductive piece and the insulation piece as far as possible. When the battery is in normal use, the fluid in the accommodation cavity may be prevented from flowing out through the gap between the conductive piece and the insulation piece, thereby enhancing the performance of airtightness.

In some embodiments of this application, when viewed in a direction perpendicular to the first direction, a saw-toothed third connecting portion is disposed on an outer periphery of the insulation piece. The fitting section is provided with a fourth connecting portion in contact with the third connecting portion.

The saw-toothed third connecting portion coordinates with the fourth connecting portion, so that the fluid pressure in the accommodation cavity pushes the fourth connecting portion to fit the third connecting portion, thereby improving the effect of airtightness between the sealing structure and the insulation piece. Under high temperature conditions, the fluid pressure increases. The fluid pressure and the elastic force of the sealing structure jointly act on a sealing element, so that the sealing element cracks more easily and the fluid in the accommodation cavity escapes smoothly along the crack.

In some embodiments of this application, the dimension of the sealing structure in the first direction is 10 μm to 1 mm.

If the sealing structure extends too much from the first wall and away from the electrode assembly, the overall dimension of the battery in the first direction will be relatively large, and the battery will occupy a larger space. However, if the sealing structure extends too little from the first wall and away from the electrode assembly, the sealing structure will deficiently fit the insulation piece, and airtightness is hardly ensured.

In some embodiments of this application, the length by which the sealing structure extends from the first wall to the insulation piece is 10 μm to 5 mm.

The dimension of the sealing structure in the direction perpendicular to the first direction is controlled to prevent the sealing structure from extending by an excessive length that affects the welding and fixing between the first wall and the sidewall. Further, the sealing structure is controlled to be more than 10 μm in size, so that the sealing structure may provide sufficient elastic deformation under high temperature conditions, and that the fitting section may crack the insulation piece by squeezing.

In some embodiments of this application, when viewed in a direction perpendicular to the first direction, a distance from an end of the sealing structure and away from the electrode assembly to the electrode assembly is less than a distance from an end of the insulation piece and away from the electrode assembly to the electrode assembly.

In this way, when approaching the battery along the first direction, an outer component generally contacts the insulation piece first. The insulation piece protrudes from the housing to protect the sealing structure and maximally avoid wear and tear on the sealing structure.

In some embodiments of this application, a thermal expansion coefficient of the insulation piece is −10×10⁻⁶/K to 10×10⁻⁶/K.

The insulation piece may be made of glass, ceramics, quartz, polyethylene, modified polyethylene materials, polypropylene, modified polypropylene materials, polyamide, modified polyamide materials, aramid, modified aramid materials, and the like, thereby reducing the risk that the crack of the material is filled through expansion after the crack occurs.

In some embodiments of this application, a thermal expansion coefficient of the sealing structure is 10×10⁻⁶/K to 40×10⁻⁶/K.

The sealing structure may be made of stainless steel, aluminum alloy, copper alloy, nickel alloy, titanium alloy, or other metals, and possesses sufficient electrical conductivity and an appropriate thermal expansion coefficient to expand under high temperature conditions to crush the insulation piece.

In some embodiments of this application, the electrode assembly includes a first electrode and a second electrode. The first electrode is electrically connected to the housing, and the second electrode is electrically connected to the conductive piece.

An embodiment of this application further provides an electronic device, including the battery.

The electronic device is powered by the battery. On the one hand, the battery is airtight sufficiently to maintain the stable operation of the battery. On the other hand, the battery may relieve pressure under a high pressure, thereby reducing the risk of explosion.

### BRIEF DESCRIPTION OF DRAWINGS

FIG. 1 is a schematic diagram of an internal structure of a battery according to an embodiment of this application;

FIG. 2 is a schematic structural diagram of a battery viewed along a first direction according to an embodiment of this application;

FIG. 3 is a schematic diagram of an internal structure of a battery according to an embodiment of this application;

FIG. 4 is a schematic diagram of an internal structure of a battery according to an embodiment of this application;

FIG. 5 is a schematic diagram of an internal structure of a battery according to an embodiment of this application;

FIG. 6 is a schematic diagram of an internal structure of a battery according to an embodiment of this application;

FIG. 7 is a schematic diagram of an internal structure of a battery according to an embodiment of this application;

FIG. 8 is a schematic diagram of an internal structure of a battery according to an embodiment of this application;

FIG. 9 is a schematic diagram of an internal structure of a battery according to an embodiment of this application;

FIG. 10 is a schematic diagram of an internal structure of a battery according to an embodiment of this application;

FIG. 11 is a schematic diagram of an internal structure of a battery according to an embodiment of this application;

FIG. 12 is a schematic diagram of an internal structure of a battery according to an embodiment of this application;

FIG. 13 is a schematic diagram of an internal structure of a battery according to an embodiment of this application;

FIG. 14 is a schematic diagram of an internal structure of a battery according to an embodiment of this application;

### DETAILED DESCRIPTION

The following describes the technical solutions in the embodiments of this application with reference to the drawings hereof. Evidently, the described embodiments are merely a part of but not all of the embodiments of this application.

It needs to be noted that a component considered to be “connected to” another component may be directly connected to the other component or may be connected to the other component through an intermediate component. A component considered to be “disposed on” another component may be directly disposed on the other component or may be disposed on the other component through an intermediate component.

Unless otherwise defined, all technical and scientific terms used herein have the same meanings as usually understood by a person skilled in the technical field of this application. The terms used in the specification of this application herein are merely intended for describing specific embodiments but are not intended to limit this application. The term “and/or” used herein includes any and all combinations of one or more related items preceding and following the term.

The terms “roughly,” “substantially,” “substantively”, and “approximately” used herein are intended to describe and represent small variations. When used with reference to an event or situation, the terms may denote an example in which the event or situation occurs exactly and an example in which the event or situation occurs very approximately. For example, when used together with a numerical value, the term may represent a variation range falling within ±10% of the numerical value, such as ±5%, ±4%, ±3%, ±2%, ±1%, ±0.5%, ±0.1%, or ±0.05% of the numerical value. For example, if a difference between two numerical values falls within ±10% of an average of the numerical values (such as ±5%, ±4%, ±3%, ±2%, ±1%, ±0.5%, ±0.1%, or ±0.05% of the average), the two numerical values may be considered “substantially” the same.

The terms “parallel” and “perpendicular” used herein are intended to describe the ideal state between two components. In the actual production or use state, one component may be approximately parallel or perpendicular to another component. For example, described together with a numerical value, “parallel” may mean that an angle between two straight lines falls within ±10°, or may mean that a dihedral angle between two planes falls within ±10°, or may mean that an angle between a straight line and a plane falls within ±10°. The term “perpendicular” may mean that an angle between two straight lines falls within 90±10°, or may mean that a dihedral angle between two planes falls within 90±10°, or may mean that an angle between a straight line and a plane falls within 90±10°. The two components described as “parallel” or “perpendicular” may be not absolute straight lines or planes, but may be roughly straight lines or planes. An object is considered to be a “straight line” or “plane” if the overall extension direction of the object is a straight line or plane as viewed from a macro perspective.

An embodiment of this application provides a battery. The battery includes a conductive piece, an electrode assembly, and a housing. The housing includes a first wall, a second wall, and a sidewall. The first wall and the second wall are disposed opposite to each other along a first direction. An accommodation cavity is formed between the first wall, the second wall, and the sidewall. The electrode assembly is disposed in the accommodation cavity. The electrode assembly includes at least one first electrode and at least one second electrode. The housing is electrically connected to the first electrode, and the first wall is provided with an opening. One end of the conductive piece is electrically connected to the second electrode in the accommodation cavity, and the other end is exposed through the opening. The battery further includes a sealing structure and an insulation piece. The sealing structure is disposed at an end that is of the first wall towards the conductive piece. The sealing structure is electrically connected to the first wall. The insulation piece is disposed between the sealing structure and the conductive piece. A thermal expansion coefficient of the sealing structure is greater than a thermal expansion coefficient of the insulation piece.

When the battery is in normal use, the sealing structure contacts the insulation piece, and coordinates with the conductive piece to seal the opening. In this way, the electrolytic solution in the battery may be maintained in the accommodation cavity, and the battery may work normally. When the battery is under an exceptionally high temperature, because the thermal expansion coefficient of the sealing structure is greater than the thermal expansion coefficient of the insulation piece, the sealing structure expands rapidly to squeeze and crack the insulation piece. A high-temperature fluid in the accommodation cavity flows out of the accommodation cavity through the crack of the insulation piece to relieve the pressure in the accommodation cavity, thereby avoiding explosion of the battery.

In this application, the thermal expansion coefficient means an increment by which the length of an object increases when the temperature rises by 1° C., measured in 1/K. The thermal expansion coefficient herein may be an average value of the thermal expansion coefficients measured when the temperature is increased from 20° C. to a specific level, for example, an average value of the thermal expansion coefficients measured when the temperature is increased from 20° C. to 150° C. When the thermal expansion coefficient is positive, it indicates that the volume expands with the rise of temperature. When the thermal expansion coefficient is negative, it indicates that the volume shrinks with the rise of temperature. The thermal expansion coefficient may be measured by a differential method (“quartz dilatometry”).

The following further describes the embodiments of this application with reference to drawings. To the extent that no conflict occurs, the following embodiments and the features in the embodiments may be combined with each other.

### Embodiment 1

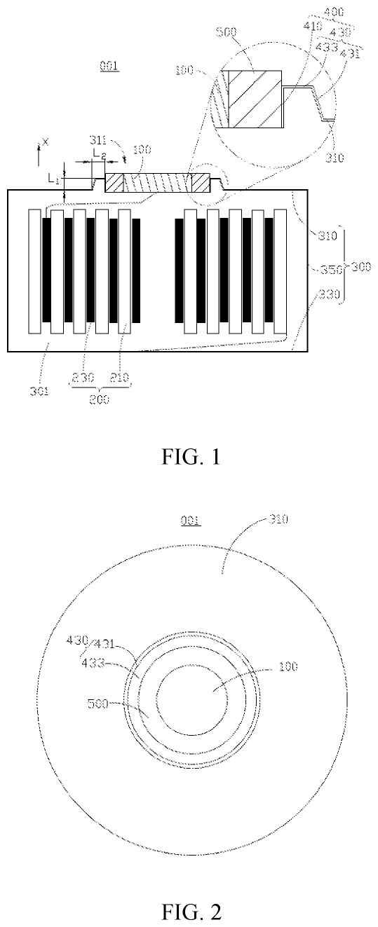

Referring to FIG. 1 and FIG. 2, a first embodiment of this application provides a battery 001, so that the battery 001 may relieve pressure under high temperature conditions, thereby reducing the risk of explosion. The battery 001 includes a conductive piece 100, an electrode assembly 200, a housing 300, a sealing structure 400, and an insulation piece 500. The housing 300 includes a first wall 310, a second wall 330, and a sidewall 350. The first wall 310 and the second wall 330 are disposed opposite to each other along a first direction X. The first wall 310 may be substantially annular in shape, and the second wall 330 may be substantially circular in shape. The first wall 310 and the second wall 330 are parallel to each other, and both perpendicular to the first direction X. One end of the sidewall 350 is connected to the first wall 310, and the other end is connected to the second wall 330, so that a substantially cylindrical accommodation cavity 301 is formed in the housing 300. The electrode assembly 200 is disposed in the accommodation cavity 301. The electrode assembly 200 includes at least one first electrode 210 and at least one second electrode 230. The first electrode 210 and the second electrode 230 are stacked in sequence. To be specific, one second electrode 230 is sandwiched between two first electrodes 210, and one first electrode 210 is sandwiched between two second electrodes 230. The first wall 310 is provided with an opening 311. In the first direction X, one end of the conductive piece 100 extends into the accommodation cavity 301 through the opening 311, and the other end is exposed through the opening 311. The housing 300 is a conductor as a whole. The housing 300 is electrically connected to the first electrode 210. The conductive piece 100 is electrically connected to the second electrode 230. When the housing 300 is connected to a first interface of an external component, and the conductive piece 100 is connected to a second interface of the external component, the battery 001 may supply power to the external component. A sealing structure 400 is disposed at an end that is of the first wall 310 towards the conductive piece 100. The sealing structure 400 is connected to the first wall 310. The sealing structure 400 may be integrated with the first wall 310. The insulation piece 500 is disposed between the sealing structure 400 and the conductive piece 100. The insulation piece 500 isolates the sealing structure 400 from the conductive piece 100, so as to reduce the short-circuit risk of the battery 001. The thermal expansion coefficient of at least one of the sealing structure 400 or the conductive piece 100 is greater than the thermal expansion coefficient of the insulation piece 500. Therefore, when the battery 001 is under high temperature conditions, at least one of the sealing structure 400 or the conductive piece 100 expands greatly in volume to squeeze the insulation piece 500. By squeezing the insulation piece 500, the sealing structure 400 cracks the surface of the insulation piece 500. The fluid in the battery 001 flows out of the accommodation cavity 301 through the cracks, thereby relieving the pressure in the accommodation cavity 301 and reducing the explosion risk of the battery 001.

Understandably, a separator (not shown in the drawing) may be further disposed between the first electrode 210 and the second electrode 230 of the electrode assembly 200. The electrode assembly 200 may be formed by winding the first electrode 210, the separator, and the second electrode 230 that are sequentially stacked.

Understandably, when the dimension of the conductive piece 100 in the first direction X is small, it is possible that one end of the conductive piece 100 does not extend into the accommodation cavity 301, or one end of the conductive piece 100 is not exposed through the opening 311. In this case, an additional conductor may be added to connect with the conductive piece 100, so that the conductive piece 100 is electrically connected to the second electrode 230. In addition, the conductive piece 100 is made to be electrically connectable to an external electrical device.

The thermal expansion coefficients of both the sealing structure 400 and the conductive piece 100 are greater than the thermal expansion coefficient of the insulation piece 500. Under high temperature conditions, the conductive piece 100 and the sealing assembly jointly squeeze the insulation piece 500, so that the insulation piece 500 may be quickly crushed. In this way, the fluid in the accommodation cavity 301 flows out rapidly to implement pressure relief in the accommodation cavity 301.

Understandably, the thermal expansion coefficient of the conductive piece 100 may be set to be greater than the thermal expansion coefficient of the insulation piece 500, and the thermal expansion coefficient of the sealing structure 400 is set to be approximately equal to the thermal expansion coefficient of the insulation piece 500 or less than the thermal expansion coefficient of the insulation piece 500. In this way, the conductive piece 100 expands to squeeze the insulation piece 500, so that cracks are generated on the surface of the insulation piece 500.

Understandably, the fluid may be a liquid such as electrolytic solution in the accommodation cavity 301, or may be a gas generated in the accommodation cavity 301.

The sealing structure 400 includes a fitting section 410 and a transition section 430. The fitting section 410 contacts the insulation piece 500. One end of the transition section 430 is connected to the fitting section 410, and the other end is connected to the first wall 310. The transition section 430, on the one hand, electrically connects the fitting section 410 to the first wall 310, and on the other hand, provides an elastic force for the fitting section 410, so that the fitting section 410 elastically fits the insulation piece 500. When the cross section of the battery 001 is viewed from a perspective perpendicular to the first direction X: from a perspective that approaches the insulation piece 500 from far off the insulation piece 500, the transition section 430 extends away from the electrode assembly 200, and the fitting section 410 extends toward the electrode assembly 200. Such extension directions of the fitting section 410 and the transition section 430 are used as examples below. Understandably, a similar technical effect may also be achieved if the fitting section 410 and the transition section 430 extend in another way. The other way of extending is: from a perspective that approaches the insulation piece 500 from far off the insulation piece 500, the transition section 430 extends toward the electrode assembly 200, and the fitting section 410 extends away from the electrode assembly 200.

Understandably, when the conductive piece 100 is located above the electrode assembly 200, that is, in the position shown in FIG. 1, if the cross section of the battery 001 is viewed from a perspective perpendicular to the first direction X: with respect to the sealing structure 400 located to the left side of the conductive piece 100, the direction that approaches the insulation piece 500 from far off the insulation piece 500 is a left-to-right direction; and, with respect to the sealing structure 400 located to the right side of the conductive piece 100, the direction that approaches the insulation piece 500 from far off the insulation piece 500 is a right-to-left direction.

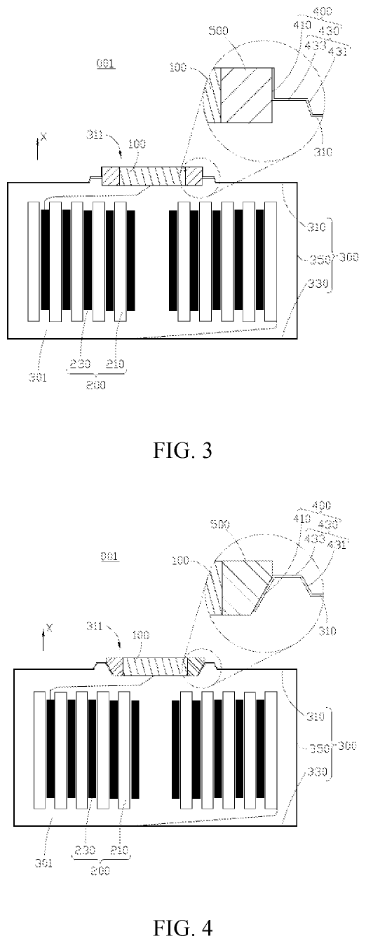

Understandably, as shown in FIG. 3, when the cross section of the battery 001 is viewed from a perspective perpendicular to the first direction X, the fitting section 410 and the transition section 430 of the sealing structure 400 may be disposed in the following way instead: from a perspective that approaches the insulation piece 500 from far off the insulation piece 500, the transition section 430 extends away from the electrode assembly 200, and the fitting section 410 also extends away from the electrode assembly 200. The part of the transition section 430 towards the fitting section 410 extends toward the insulation piece 500 in a direction substantially perpendicular to the first direction X. When the cross section of the battery 001 is viewed from a perspective perpendicular to the first direction X, the part of the transition section 430 towards the fitting section 410 may be arc-shaped.

Understandably, the sealing structure 400 that contains the fitting section 410 and the transition section 430 is elastic to some extent. In this way, the sealing structure 400 elastically abuts against the outer periphery of the insulation piece 500 to seal the outer periphery of the insulation piece 500, thereby ensuring that the electrolytic solution in the accommodation cavity 301 may be maintained in the accommodation cavity 301 without leakage when the battery 001 is in normal use.

In the first direction X, the fitting section 410 and the transition section 430 extend oppositely to form an arcuate structure, so that the fitting section 410 elastically contacts the insulation piece 500. Under high temperature conditions, the arcuate structure may provide a larger amount of aggregate deformation, so that the fitting section 410 exerts a greater extrusion force on the insulation piece 500, and that the insulation piece 500 may be crushed more easily.

The transition section 430 includes a first sub-section 431 and a second sub-section 433. The first sub-section 431 extends from the first wall 310 and away from the electrode assembly 200. The second sub-section 433 extends from the first sub-section 431 to the insulation piece 500. With this structure, the stress between the fitting section 410 and the transition section 430 is further dispersed, and the sealing structure 400 achieves higher strength.

The angle between the first sub-section 431 and the first wall 310 is controlled to be 85° to 175°. Under favorable conditions, the angle between the first sub-section 431 and the first wall 310 may be greater than or equal to 90°. The sealing structure 400 may be of high strength. The transition section 430 may provide a sufficient elastic force for the fitting section 410 to fit the insulation piece 500, so that the sealing structure 400 may squeeze the insulation piece 500 under high temperature conditions until the insulation piece 500 is ruptured.

The angle between the first sub-section 431 and the second sub-section 433 is 85° to 175°. Under favorable conditions, the angle between the first sub-section 431 and the second sub-section 433 is greater than or equal to 90°. The sealing structure 400 may be of high strength. The transition section 430 may provide a sufficient elastic force for the fitting section 410 to fit the insulation piece 500, so that the sealing structure 400 may squeeze the insulation piece 500 under high temperature conditions until the insulation piece 500 is ruptured.

The angle between the second sub-section 433 and the fitting section 410 may be selected depending on the shape of the outer wall at which the insulation piece 500 contacts the fitting section 410. As shown in FIG. 1, the outer wall at which the insulation piece 500 contacts the fitting section 410 is parallel to the first direction X, and the second sub-section 433 extends perpendicular to the first direction X. In this case, the second sub-section 433 is at a right angle to the fitting section 410, so that the fitting section 410 may fit the outer wall of the insulation piece 500 by a large area. As shown in FIG. 4, the outer wall at which the insulation piece 500 contacts the fitting section 410 is not parallel to the first direction X, and the second sub-section 433 extends perpendicular to the first direction X. In this case, the second sub-section 433 is at an obtuse angle to the fitting section 410, so that the fitting section 410 may fit the outer wall of the insulation piece 500 by a large area.

The insulation piece 500 is generally cylindrical. Therefore, the fitting section 410 extends from the second sub-section 433 to the electrode assembly 200, and the angle between the fitting section 410 and the second sub-section 433 is controlled to be 80° to 100°. This achieves close fitting between the fitting section 410 and the insulation piece 500. Moreover, the junction between the fitting section 410 and the second sub-section 433 may reduce stress concentration. In addition, a thrust force may be generated by the junction between the fitting section 410 and the second sub-section 433. The thrust force causes the fitting section 410 to squeeze the insulation piece 500.

The extension amount of the sealing structure 400 that extends from the first wall 310 and away from the electrode assembly 200 is related to the space utilization of the battery 001. The extension amount of the sealing structure 400 that extends from the first wall 310 and away from the electrode assembly 200 is controlled to be within a specific range, so as to help improve the space utilization of the battery 001. Further, the extension amount of the sealing structure 400 that extends from the first wall 310 and away from the electrode assembly 200 is related to the airtightness performance of the battery 001. The extension amount of the sealing structure 400 that extends from the first wall 310 and away from the electrode assembly 200 is controlled to be greater than a specific value, so as to help improve the airtightness of the battery 001. The length by which the sealing structure 400 extends from the first wall 310 and away from the electrode assembly 200 is a first length L₁. That is, the length by which the sealing structure 400 extends in the first direction X is the first length L₁. The first length L₁ is controlled to be in the range of 10 μm to 1 mm. The effect is satisfactory when the first length L₁ is controlled to be 500 μm to 700 μm.

The dimension of the sealing structure 400 in the direction perpendicular to the first direction X is controlled to be a specific value, so as to reduce the risk of extending the sealing structure 400 by an excessive length that affects the welding and fixing between the first wall 310 and the sidewall 350. The dimension of the sealing structure 400 in the direction perpendicular to the first direction X is controlled to be greater than a specific value, so that the sealing structure 400 may provide sufficient elastic deformation under high temperature conditions, and that the fitting section 410 may crack the insulation piece 500 more easily by squeezing. The length by which the sealing structure 400 extends from the first wall 310 to the insulation piece 500 is a second length L₂. That is, the length by which the sealing structure 400 extends perpendicular to the first direction X is the second length L₂. The second length L₂ is controlled to be within a range of 10 μm to 5 mm. The effect is satisfactory when the second length L₂ is controlled to be 400 μm to 600 μm.

The insulation piece 500 is flush with the conductive piece 100 at a battery end away from the electrode assembly 200, thereby keeping flatness of the outer surface of the battery 001 and improving the space utilization of the battery 001 in the first direction X.

When viewed in a direction perpendicular to the first direction X, the distance from the end of the sealing structure 400 and away from the electrode assembly 200 to the electrode assembly 200 is less than the distance from the end of the insulation piece 500 and away from the electrode assembly 200 to the electrode assembly 200.

That is, the end of the sealing structure 400, which faces away from the electrode assembly 200, is located on a side of an end of the insulation piece 500, where the end faces away from the electrode assembly 200, and the side is close to the electrode assembly 200. That is, the end of the sealing structure 400, which faces away from the electrode assembly 200, is located between the end of the insulation piece 500 and the electrode assembly 200, where the end faces away from the electrode assembly 200. In this way, when approaching the battery 001 along the first direction X, an outer component generally contacts the insulation piece 500 first. The insulation piece 500 protrudes from the housing 300 to protect the sealing structure 400 and reduce the risk of wear and tear on the sealing structure 400.

The conductive piece 100 is made of a metal material, so as to be electrically conductive on the one hand, and achieve a relatively large thermal expansion coefficient on the other hand. The insulation piece is made of an insulator such as glass, and is brittle in nature and may break and crack under compression. The housing 300 and the sealing structure 400 may be integrated. The housing 300 and the sealing structure 400 may also be made of a metal material, so as to be electrically conductive on the one hand, and achieve a relatively large thermal expansion coefficient on the other hand.

Understandably, the sealing structure 400 and the housing 300 may be not integrated. In the case that the sealing structure 400 and the housing 300 are formed discretely, the sealing structure 400 is fixedly connected to the housing 300 by welding or the like.

The battery that adopts the foregoing structure is tested to obtain the pass rate under different conditions, where the first wall 310 and the sealing structure 400 are made of the same material, and the conductive piece 100, the insulation piece 500, and the sealing structure 400 are made of different materials. The test results are shown in Table 1.

TABLE 1

| | Conductive piece | | Insulation piece | | Sealing structure | | Test pass rate | | | |
|---|---|---|---|---|---|---|---|---|---|---|
| | Material | TEC | Material | TEC | Material | TEC | A | B | C | D |
| Comparative | Stainless | 14.5 | Polyethylene | 220 | — | — | 100% | 60% | 0% | 0% |
| Embodiment 1 | steel | | | | | | | | | |
| Embodiment 1 | Aluminum | 23.3 | Glass | 7.1 | Stainless | 14.5 | 100% | 100% | 50% | 100% |
| | alloy | | | | steel | | | | | |
| Embodiment 2 | Aluminum | 23.8 | Glass | 4.5 | Stainless | 13 | 100% | 100% | 50% | 100% |
| | alloy | | | | steel | | | | | |
| Embodiment 3 | Stainless | 15 | Glass | 3.25 | Stainless | 11.8 | 100% | 100% | 50% | 100% |
| | steel | | | | steel | | | | | |
| Embodiment 4 | Aluminum | 23.8 | Ceramics | 3 | Stainless | 14.5 | 100% | 100% | 50% | 100% |
| | alloy | | | | steel | | | | | |
| Embodiment 5 | Aluminum | 23.8 | Organic | −4.1 | Stainless | 13 | 100% | 100% | 50% | 100% |
| | alloy | | insulation | | steel | | | | | |
| | | | material | | | | | | | |
| Embodiment 6 | Stainless | 15 | Glass | 7.1 | Copper | 18.5 | 100% | 100% | 50% | 100% |
| | steel | | | | alloy | | | | | |
| Embodiment 7 | Aluminum | 23.8 | Glass | 4.5 | Stainless | 14.5 | 100% | 100% | 50% | 100% |
| | alloy | | | | steel | | | | | |
| Embodiment 8 | Stainless | 15 | Glass | 3.25 | Stainless | 13 | 100% | 100% | 50% | 100% |
| | steel | | | | steel | | | | | |

In Table 1 and other tables in the application, conditions A (abbreviated as A), B (abbreviated as B), and C (abbreviated as C) are high-temperature and high-humidity test conditions, and condition D (abbreviated as D) is a test condition in which the temperature increases linearly. Thermal expansion coefficient with 10⁻⁶/K as unit is abbreviated as TEC.

High-temperature and high-humidity test: Charging a battery under a room temperature until the SOC (State of Charge) reaches 100%, and then storing the battery in a test furnace in which the temperature is 65° C. and the relative humidity is 90%. After the battery is stored for a period, checking the appearance of the battery for electrolyte leakage. If there is no leakage, the test is passed. Condition A is to store for 21 days, condition B is to store for 42 days, and condition C is to store 63 days.

Testing the battery under linearly increasing temperatures: Charging the battery under a room temperature until the SOC (State of Charge) reaches 100%, and checking the appearance of the battery. Then putting the battery in an oven in which the temperature increases to an upper limit of 250° C. at a speed of 5° C. per minute.

Stopping increasing the temperature when the temperature reaches the upper limit or when the open circuit voltage of the battery becomes lower than 2.0 V before the temperature reaches the upper limit. Checking whether the battery explodes or burns. If there is no explosion or burn, the test is passed.

The meanings of condition A, condition B, condition C, and condition D in subsequent tests are the same as above.

In Comparative Embodiment 1 in Table 1, the sealing structure 400 is not provided, and the insulation piece 500 is directly connected by the first wall 310. As may be seen from Table 1, the battery 001 adopting such a sealing structure 400 may significantly reduce the probability of explosion under high temperatures. Moreover, under the conditions of a 65° C. temperature and a 90% humidity, not only the risk of explosion of the battery 001 is reduced, but also the battery 001 may be kept from leaking the electrolytic solution for a long period.

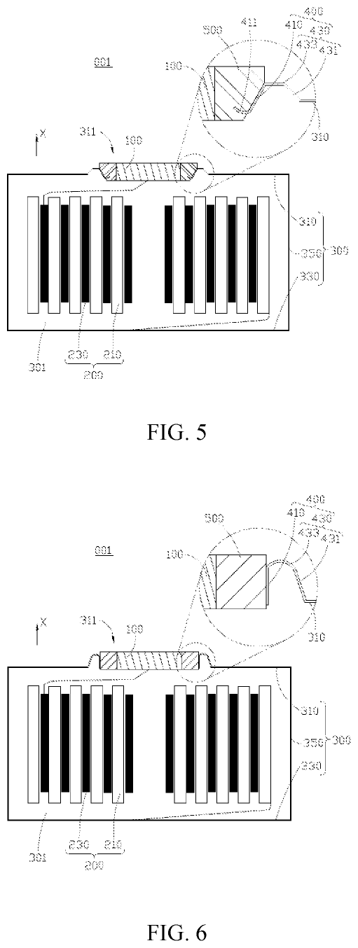

Referring to FIG. 5, in order to further increase the strength of the junction between the fitting section 410 and the insulation piece 500, an inset 411 is disposed in the fitting section 410, and a slot for inserting the inset 411 is disposed in the insulation piece 500. When the insulation piece 500 contacts the sealing structure 400, the inset 411 is inserted into the slot to enhance the strength at the junction between the sealing structure 400 and the insulation piece 500. On an interface parallel to the first direction X, the inset 411 resembles a barb protruding toward the electrode assembly 200.

The batteries with the foregoing structure are tested under different conditions to obtain pass rates, and the test results are shown in Table 2.

TABLE 2

| | Conductive piece | | Insulation piece | | Sealing structure | | Test pass rate | | | |
|---|---|---|---|---|---|---|---|---|---|---|
| | Material | TEC | Material | TEC | Material | TEC | A | B | C | D |
| Comparative | Stainless | 14.5 | Polyethylene | 220 | — | — | 100% | 60% | 0% | 0% |
| Embodiment 1 | steel | | | | | | | | | |
| Embodiment 9 | Aluminum | 23.3 | Glass | 7.1 | Stainless | 14.5 | 100% | 100% | 50% | 100% |
| | alloy | | | | steel | | | | | |

In Comparative Embodiment 1 in Table 2, the sealing structure 400 is not provided, and the insulation piece 500 is directly connected by the first wall 310. As may be seen from Table 2, the battery 001 adopting such a sealing structure 400 may significantly reduce the risk of explosion under high temperatures. Moreover, under the conditions of a 65° C. temperature and a 90% humidity, not only the probability of explosion of the battery 001 is reduced, but also the battery 001 may be kept from leaking the electrolytic solution for a long period.

When the battery 001 is in normal use, the sealing structure 400 contacts the insulation piece 500, and coordinates with the conductive piece 100 to seal the opening 311. In this way, the electrolytic solution in the battery 001 may be maintained in the accommodation cavity 301, and the battery 001 may work normally. When the battery 001 is under an exceptionally high temperature, because the thermal expansion coefficient of the insulation piece 500 is greater than the thermal expansion coefficient of the sealing structure 400, the sealing structure 400 expands rapidly to squeeze the insulation piece 500 and crack the insulation piece 500. The high-temperature fluid in the accommodation cavity 301 flows out of the accommodation cavity 301 through the crack of the insulation piece 500 to relieve the pressure in the accommodation cavity 301, thereby avoiding explosion of the battery 001.

### Embodiment 2

Referring to FIG. 6, the second embodiment of this application provides a battery 001. The battery 001 in this embodiment differs from the battery 001 in Embodiment 1 in:

The second sub-section 433 is designed as an arc-shape to reduce stress concentration in the sealing structure 400. Because the first sub-section 431 extends away from the electrode assembly 200 and the fitting section 410 extends toward the fitting section 410, the second sub-section 433 is designed as an arc shape protruding away from the electrode assembly 200. In this way, the junction between the second sub-section 433 and the first sub-section 431 takes on an obtuse angle, and the junction between the second sub-section 433 and the fitting section 410 also takes on an obtuse angle.

The batteries with the foregoing structure are tested under different conditions to obtain pass rates, and the test results are shown in Table 3.

TABLE 3

| | Conductive piece | | Insulation piece | | Sealing structure | | Test pass rate | | | |
|---|---|---|---|---|---|---|---|---|---|---|
| | Material | TEC | Material | TEC | Material | TEC | A | B | C | D |
| Comparative | Stainless | 14.5 | Polyethylene | 220 | — | — | 100% | 60% | 0% | 0% |
| Embodiment 1 | steel | | | | | | | | | |
| Embodiment 10 | Aluminum | 23.3 | Glass | 7.1 | Stainless | 14.5 | 100% | 100% | 50% | 100% |
| | alloy | | | | steel | | | | | |

In Comparative Embodiment 1 in Table 3, the sealing structure 400 is not provided, and the insulation piece 500 is directly connected by the first wall 310. As may be seen from Table 3, the battery 001 adopting such a sealing structure 400 may significantly reduce the probability of explosion under high temperatures. Moreover, under the conditions of a 65° C. temperature and a 90% humidity, not only the risk of explosion of the battery 001 is reduced, but also the battery 001 may be kept from leaking the electrolytic solution for a long period.

### Embodiment 3

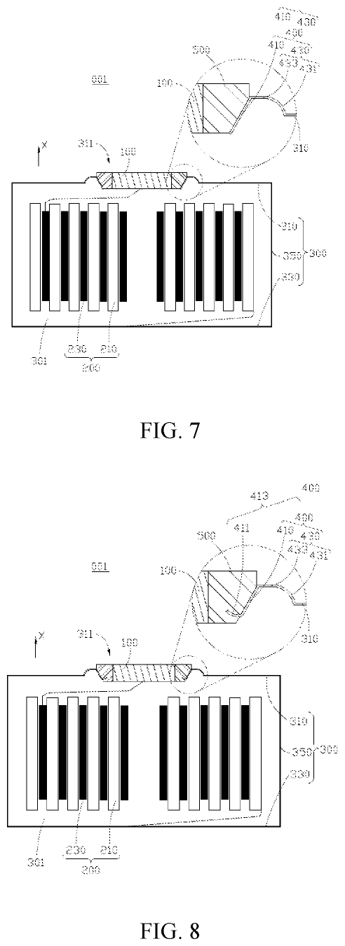

Referring to FIG. 7, the third embodiment of this application provides a battery 001. The battery 001 in this embodiment differs from the battery 001 in Embodiment 1 in:

The first sub-section 431 is designed as an arc-shape to reduce stress concentration in the sealing structure 400. Because the first sub-section 431 extends away from the electrode assembly 200, the first sub-section 431 is designed as an arc shape protruding away from the electrode assembly 200 and the sealing element. In this way, the junction between the first sub-section 431 and the first wall 310 takes on an obtuse angle, and the junction between the first sub-section 431 and the second sub-section 433 also takes on an obtuse angle.

Referring to FIG. 8, in order to further increase the strength of the junction between the fitting section 410 and the insulation piece 500, an inset 411 is disposed in the fitting section 410, and a slot for inserting the inset 411 is disposed in the insulation piece 500. When the insulation piece 500 contacts the sealing structure 400, the inset 411 is inserted into the slot to enhance the strength at the junction between the sealing structure 400 and the insulation piece 500. On an interface parallel to the first direction X, the inset 411 resembles a barb protruding toward the electrode assembly 200.

The batteries with the foregoing structure are tested under different conditions to obtain pass rates, and the test results are shown in Table 4.

TABLE 4

| | Conductive piece | | Insulation piece | | Sealing structure | | Test pass rate | | | |
|---|---|---|---|---|---|---|---|---|---|---|
| | Material | TEC | Material | TEC | Material | TEC | A | B | C | D |
| Comparative | Stainless | 14.5 | Polyethylene | 220 | — | — | 100% | 60% | 0% | 0% |
| Embodiment 1 | steel | | | | | | | | | |
| Embodiment 11 | Aluminum | 23.3 | Glass | 7.1 | Stainless | 14.5 | 100% | 100% | 50% | 100% |
| | alloy | | | | steel | | | | | |

In Comparative Embodiment 1 in Table 4, the sealing structure 400 is not provided, and the insulation piece 500 is directly connected by the first wall 310. As may be seen from Table 4, the battery 001 adopting such a sealing structure 400 may significantly reduce the risk of explosion under high temperatures. Moreover, under the conditions of a 65° C. temperature and a 90% humidity, not only the probability of explosion of the battery 001 is reduced, but also the battery 001 may be kept from leaking the electrolytic solution for a long period.

### Embodiment 4

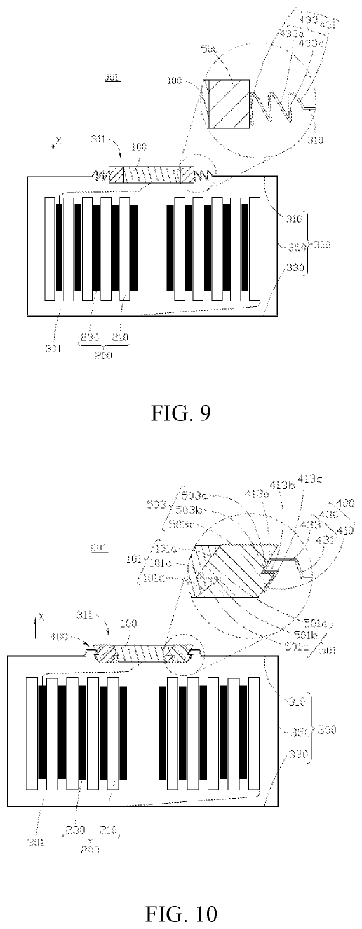

Referring to FIG. 9, the fourth embodiment of this application provides a battery 001. The battery 001 in this embodiment differs from the battery 001 in Embodiment 1 in:

The second sub-section 433 is designed as a wave shape when viewed along a direction perpendicular to the first direction X. The second sub-section 433 includes a plurality of convex sections 433a and concave sections 433b that are alternately connected. When viewed from the first wall 310 toward the insulation piece 500, each convex section 433a extends away from the electrode assembly 200, and each concave section 433b extends toward the electrode assembly 200. Two adjacent convex sections 433a are connected by a concave section 433b, and two adjacent concave sections 433b are connected by a convex section 433a. The convex section 433a is connected to the concave section 433b arcuately, thereby reducing the stress concentration in the sealing structure 400.

The batteries with the foregoing structure are tested under different conditions to obtain pass rates, and the test results are shown in Table 2.

TABLE 5

| | Conductive piece | | Insulation piece | | Sealing structure | | Test pass rate | | | |
|---|---|---|---|---|---|---|---|---|---|---|
| | Material | TEC | Material | TEC | Material | TEC | A | B | C | D |
| Comparative | Stainless | 14.5 | Polyethylene | 220 | — | — | 100% | 60% | 0% | 0% |
| Embodiment 1 | steel | | | | | | | | | |
| Embodiment 12 | Aluminum | 23.3 | Glass | 7.1 | Stainless | 14.5 | 100% | 100% | 50% | 100% |
| | alloy | | | | steel | | | | | |

In Comparative Embodiment 1 in Table 5, the sealing structure 400 is not provided, and the insulation piece 500 is directly connected by the first wall 310. As may be seen from Table 5, the battery 001 adopting such a sealing structure 400 may significantly reduce the risk of explosion under high temperatures. Moreover, under the conditions of a 65° C. temperature and a 90% humidity, not only the probability of explosion of the battery 001 is reduced, but also the battery 001 may be kept from leaking the electrolytic solution for a long period.

### Embodiment 5

Referring to FIG. 10, the fifth embodiment of this application provides a battery 001. The battery 001 in this embodiment differs from the battery 001 in Embodiment 1 in:

When viewed in a direction perpendicular to the first direction X, a saw-toothed first connecting portion 101 is disposed on the outer periphery of the conductive piece 100, and the insulation piece 500 is provided with a second connecting portion 501 in contact with the first connecting portion 101.

The first connecting portion 101 includes a first bend section 101a, a second bend section 101b, and a third bend section 101c. Along a direction that approaches the electrode assembly 200 from far off the electrode assembly 200, the first bend section 101a, the second bend section 101b, and the third bend section 101c are connected sequentially. The first bend section 101a extends away from the first wall 310. The second bend section 101b extends toward the first wall 310. The third bend section 101c extends away from the first wall 310.

The second connecting portion 501 includes a fourth bend section 501a, a fifth bend section 501b, and a sixth bend section 501c. The fourth bend section 501a contacts the first bend section 101a, the fifth bend section 501b contacts the second bend section 101b, and the sixth bend section 501c contacts the third bend section 101c.

The extension directions of the second bend section 101b and the fifth bend section 501b are perpendicular to the first direction X.

The first connecting portion 101 coordinates with the second connecting portion 501 to make the conductive piece 100 fit the insulation piece 500 more closely, thereby avoiding existence of a gap between the conductive piece 100 and the insulation piece 500 as far as possible. When the battery 001 is in normal use, the fluid in the accommodation cavity 301 is prevented, as far as possible, from flowing out through the gap between the conductive piece 100 and the insulation piece 500.

When viewed in a direction perpendicular to the first direction X, a saw-toothed third connecting portion 503 is disposed on the outer periphery of the insulation piece 500, and the fitting section 410 is provided with a fourth connecting portion 413 in contact with the third connecting portion 503.

The third connecting portion 503 includes a seventh bend section 503a, an eighth bend section 503b, and a ninth bend section 503c. Along a direction that approaches the electrode assembly 200 from far off the electrode assembly 200, the seventh bend section 503a, the eighth bend section 503b, and the ninth bend section 503c are connected sequentially. The seventh bend section 503a extends toward the conductive piece 100. The eighth bend section 503b extends away from the conductive piece 100. The ninth bend section 503c extends toward the conductive piece 100.

The fourth connecting portion 413 includes a tenth bend section 413a, an eleventh bend section 413b, and a twelfth bend section 413c. The tenth bend section 413a contacts the seventh bend section 503a, the eleventh bend section 413b contacts the eighth bend section 503b, and the twelfth bend section 413c contacts the ninth bend section 503c.

The extension directions of the eighth bend section 503b and the eleventh bend section 413b are perpendicular to the first direction X.

The first connecting portion 101 coordinates with the second connecting portion 501 to make the sealing structure 400 fit the insulation piece 500 more closely, thereby avoiding existence of a gap between the sealing structure 400 and the insulation piece 500 as far as possible. When the battery 001 is in normal use, the fluid in the accommodation cavity 301 is prevented, as far as possible, from flowing out through the gap between the sealing structure 400 and the insulation piece 500.

Moreover, when the pressure in the accommodation cavity 301 increases, the pressure in the accommodation cavity 301 is exerted on the first connecting portion 101. The first connecting portion 101 exerts a greater pressure on the second connecting portion, thereby ensuring the airtightness of the battery 001. In addition, when the pressure in the accommodation cavity 301 is exceptionally high, the first connecting portion 101 may exert a greater pressure on the second connecting portion 501 to crush the insulation piece 500, so that a crack is generated on the surface of the insulation piece 500 to relieve the pressure.

The batteries with the foregoing structure are tested under different conditions to obtain pass rates, and the test results are shown in Table 6.

TABLE 6

| | Conductive piece | | Insulation piece | | Sealing structure | | Test pass rate | | | |
|---|---|---|---|---|---|---|---|---|---|---|
| | Material | TEC | Material | TEC | Material | TEC | A | B | C | D |
| Comparative | Stainless | 14.5 | Polyethylene | 220 | — | — | 100% | 60% | 0% | 0% |
| Embodiment 1 | steel | | | | | | | | | |
| Embodiment 13 | Aluminum | 23.3 | Glass | 7.1 | Stainless | 14.5 | 100% | 100% | 100% | 100% |
| | alloy | | | | steel | | | | | |

In Comparative Embodiment 1 in Table 6, the sealing structure 400 is not provided, and the insulation piece 500 is directly connected by the first wall 310. As may be seen from Table 6, the battery 001 adopting such a sealing structure 400 may significantly reduce the risk of explosion under high temperatures. Moreover, under the conditions of a 65° C. temperature and a 90% humidity, not only the probability of explosion of the battery 001 is reduced, but also the battery 001 may be kept from leaking the electrolytic solution for a long period.

As may be seen from comparison between Tables 1 to 5, the battery 001 still achieves a high pass rate under the harsh condition C. The first connecting portion 101, the second connecting portion 501, the third connecting portion 503, and the fourth connecting portion 413, each containing a plurality of bend sections, may further improve the airtightness performance. The third connecting portion 503 and the fourth connecting portion 413 may increase the extrusion force on the insulation piece 500 under high temperature conditions, so that the insulation piece 500 may crack more easily under the extrusion force.

### Embodiment 6

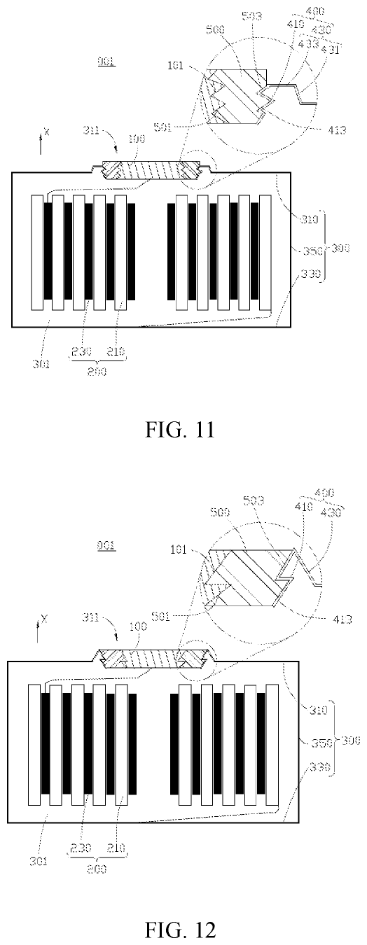

Referring to FIG. 11, the sixth embodiment of this application provides a battery 001. The battery 001 in this embodiment differs from the battery 001 in Embodiment 5 in:

The first connecting portion 101 contains six bend sections along the first direction X. The extension direction of no bend section of the first connecting portion 101 is perpendicular to the first direction X.

The second connecting portion 501 coordinates with the first connecting portion 101 to reduce the probability of existence of a gap between the conductive piece 100 and the insulation piece 500.

The third connecting portion 503 contains five bend sections along the first direction X. The extension direction of no bend section of the third connecting portion 503 is perpendicular to the first direction X.

The fourth connecting portion 413 coordinates with the third connecting portion 503 to reduce the probability of existence of a gap between the conductive piece 100 and the insulation piece 500.

The batteries with the foregoing structure are tested under different conditions to obtain pass rates, and the test results are shown in Table 7.

TABLE 7

| | Conductive piece | | Insulation piece | | Sealing structure | | Test pass rate | | | |
|---|---|---|---|---|---|---|---|---|---|---|
| | Material | TEC | Material | TEC | Material | TEC | A | B | C | D |
| Comparative | Stainless | 14.5 | Polyethylene | 220 | — | — | 100% | 60% | 0% | 0% |
| Embodiment 1 | steel | | | | | | | | | |
| Embodiment 14 | Aluminum | 23.3 | Glass | 7.1 | Stainless | 14.5 | 100% | 100% | 100% | 100% |
| | alloy | | | | steel | | | | | |

In Comparative Embodiment 1 in Table 7, the sealing structure 400 is not provided, and the insulation piece 500 is directly connected by the first wall 310. As may be seen from Table 7, the battery 001 adopting such a sealing structure 400 may significantly reduce the risk of explosion under high temperatures. Moreover, under the conditions of a 65° C. temperature and a 90% humidity, not only the probability of explosion of the battery 001 is reduced, but also the battery 001 may be kept from leaking the electrolytic solution for a long period.

As may be seen from comparison between Tables 1 to 5, the battery 001 still achieves a high pass rate under the harsh condition C. The first connecting portion 101, the second connecting portion 501, the third connecting portion 503, and the fourth connecting portion 413, each containing a plurality of bend sections, may further improve the airtightness performance. The third connecting portion 503 and the fourth connecting portion 413 may increase the extrusion force on the insulation piece 500 under high temperature conditions, so that the insulation piece 500 may crack more easily under the extrusion force.

### Embodiment 7

Referring to FIG. 12, the seventh embodiment of this application provides a battery 001. The battery 001 in this embodiment differs from the battery 001 in Embodiment 5 in:

A first sub-section 431 and a second sub-section 433 that are at an angle to each other are not included in the transition section 430. From a perspective that approaches the conductive piece 100 from far off the conductive piece 100, the transition section 430 extends away from the electrode assembly 200.

The batteries with the foregoing structure are tested under different conditions to obtain pass rates, and the test results are shown in Table 8.

TABLE 8

| | Conductive piece | | Insulation piece | | Sealing structure | | Test pass rate | | | |
|---|---|---|---|---|---|---|---|---|---|---|
| | Material | TEC | Material | TEC | Material | TEC | A | B | C | D |
| Comparative | Stainless | 14.5 | Polyethylene | 220 | — | — | 100% | 60% | 0% | 0% |
| Embodiment 1 | steel | | | | | | | | | |
| Embodiment 15 | Aluminum | 23.3 | Glass | 7.1 | Stainless | 14.5 | 100% | 100% | 100% | 100% |
| | alloy | | | | steel | | | | | |

In Comparative Embodiment 1 in Table 8, the sealing structure 400 is not provided, and the insulation piece 500 is directly connected by the first wall 310. As may be seen from Table 8, the battery 001 adopting such a sealing structure 400 may significantly reduce the risk of explosion under high temperatures. Moreover, under the conditions of a 65° C. temperature and a 90% humidity, not only the probability of explosion of the battery 001 is reduced, but also the battery 001 may be kept from leaking the electrolytic solution for a long period.

As may be seen from comparison between Tables 1 to 5, the battery 001 still achieves a high pass rate under the harsh condition C. The first connecting portion 101, the second connecting portion 501, the third connecting portion 503, and the fourth connecting portion 413, each containing a plurality of bend sections, may further improve the airtightness performance. The third connecting portion 503 and the fourth connecting portion 413 may increase the extrusion force on the insulation piece 500 under high temperature conditions, so that the insulation piece 500 may crack more easily under the extrusion force.

### Embodiment 8

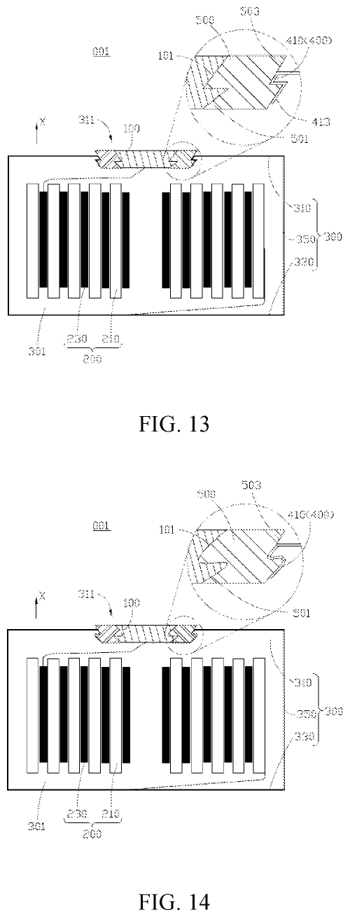

Referring to FIG. 13, the eighth embodiment of this application provides a battery 001. The battery 001 in this embodiment differs from the battery 001 in Embodiment 5 in:

The fitting section 410 formed by a plurality of bend sections may utilize the pressure in the accommodation cavity 301, and therefore, is less dependent on the elasticity of the transition section 430. Therefore, the transition section 430 may be simplified.

With the transition section 430 omitted, the first wall 310 is directly connected to the fitting section 410. The saw-toothed fitting section 410 generates an elastic thrust force to fit the insulation piece 500. The fluid pressure in the accommodation cavity 301 acts on the fitting section 410 to enhance the effect of airtightness between the fitting section 410 and the insulation piece 500. Under high temperature conditions, the fitting section 410 thermally expands to increase the pressure on the insulation piece 500. The high pressure in the accommodation cavity 301 also exerts a relatively large pressure on the fitting section 410. The two pressures combine to crush the insulation piece 500 to generate a crack on the surface of the insulation piece 500. The fluid in the accommodation cavity 301 flows out through the crack to relieve the pressure in the battery 001.

The batteries with the foregoing structure are tested under different conditions to obtain pass rates, and the test results are shown in Table 9.

TABLE 9

| | Conductive piece | | Insulation piece | | Sealing structure | | Test pass rate | | | |
|---|---|---|---|---|---|---|---|---|---|---|
| | Material | TEC | Material | TEC | Material | TEC | A | B | C | D |
| Comparative | Stainless | 14.5 | Polyethylene | 220 | — | — | 100% | 60% | 0% | 0% |
| Embodiment 1 | steel | | | | | | | | | |
| Embodiment 16 | Aluminum | 23.3 | Glass | 7.1 | Stainless | 14.5 | 100% | 100% | 100% | 100% |
| | alloy | | | | steel | | | | | |

In Comparative Embodiment 1 in Table 9, the sealing structure 400 is not provided, and the insulation piece 500 is directly connected by the first wall 310. As may be seen from Table 9, the battery 001 adopting such a sealing structure 400 may significantly reduce the probability of explosion under high temperatures. Moreover, under the conditions of a 65° C. temperature and a 90% humidity, not only the risk of explosion of the battery 001 is reduced, but also the battery 001 may be kept from leaking the electrolytic solution for a long period.

As may be seen from comparison between Tables 1 to 5, the battery 001 still achieves a high pass rate under the harsh condition C. The first connecting portion 101, the second connecting portion 501, the third connecting portion 503, and the fourth connecting portion 413, each containing a plurality of bend sections, may further improve the airtightness performance. The third connecting portion 503 and the fourth connecting portion 413 may increase the extrusion force on the insulation piece 500 under high temperature conditions, so that the insulation piece 500 may crack more easily under the extrusion force.

### Embodiment 9

Referring to FIG. 14, the ninth embodiment of this application provides a battery 001. The battery 001 in this embodiment differs from the battery 001 in Embodiment 8 in:

The bend sections of the first connecting portion 101 are interconnected arcuately.

The bend sections of the second connecting portion 501 are interconnected arcuately.

The bend sections of the third connecting portion 503 are interconnected arcuately.

The bend sections of the fourth connecting portion 413 are interconnected arcuately.

The batteries with the foregoing structure are tested under different conditions to obtain pass rates, and the test results are shown in Table 10.

TABLE 10

| | Conductive piece | | Insulation piece | | Sealing structure | | Test pass rate | | | |
|---|---|---|---|---|---|---|---|---|---|---|
| | Material | TEC | Material | TEC | Material | TEC | A | B | C | D |
| Comparative | Stainless | 14.5 | Polyethylene | 220 | — | — | 100% | 60% | 0% | 0% |
| Embodiment 1 | steel | | | | | | | | | |
| Embodiment 17 | Aluminum | 23.3 | Glass | 7.1 | Stainless | 14.5 | 100% | 100% | 100% | 100% |
| | alloy | | | | steel | | | | | |

In Comparative Embodiment 1 in Table 10, the sealing structure 400 is not provided, and the insulation piece 500 is directly connected by the first wall 310. As may be seen from Table 10, the battery 001 adopting such a sealing structure 400 may significantly reduce the probability of explosion under high temperatures. Moreover, under the conditions of a 65° C. temperature and a 90% humidity, not only the probability of explosion of the battery 001 is reduced, but also the battery 001 may be kept from leaking the electrolytic solution for a long period.

As may be seen from comparison between Tables 1 to 5, the battery 001 still achieves a high pass rate under the harsh condition C. The first connecting portion 101, the second connecting portion 501, the third connecting portion 503, and the fourth connecting portion 413, each containing a plurality of bend sections, may further improve the airtightness performance. The third connecting portion 503 and the fourth connecting portion 413 may increase the extrusion force on the insulation piece 500 under high temperature conditions, so that the insulation piece 500 may crack more easily under the extrusion force.

When the battery 001 is in normal use, the sealing structure 400 contacts the insulation piece 500, and coordinates with the conductive piece 100 to seal the opening 311. In this way, the electrolytic solution in the battery 001 may be maintained in the accommodation cavity 301, and the battery 001 may work normally. When the battery 001 is under an exceptionally high temperature, because the thermal expansion coefficient of the insulation piece 500 is greater than the thermal expansion coefficient of the sealing structure 400, the sealing structure 400 expands rapidly to squeeze the insulation piece 500 and crack the insulation piece 500. The high-temperature fluid in the accommodation cavity 301 flows out of the accommodation cavity 301 through the crack of the insulation piece 500 to relieve the pressure in the accommodation cavity 301, thereby avoiding explosion of the battery 001.

### Embodiment 10

The tenth embodiment of this application provides an electronic device. The electronic device includes a power consumption structure and the battery 001 according to Embodiment 1. The battery 001 is electrically connected to the power consumption structure, and the battery 001 provides electrical energy to the power consumption structure.

Understandably, the electronic device may include the battery 001 according to any one of Embodiments 2 to 9 instead.

When powered by the battery 001, the electronic device may work stably and reduce the risk of explosion of the battery 001 under high temperature conditions.

In addition, a person skilled in the art may make other variations to this application without departing from the essence of this application. The variations made based on the content of this application fall within the scope of disclosure of this application.

What is claimed is:

1. A battery, comprising: a conductive piece, an electrode assembly and a housing; wherein the housing comprises a first wall, a second wall and a sidewall connected to the first wall and the second wall respectively; the first wall and the second wall are disposed opposite to each other along a first direction; an accommodation cavity is formed between the first wall, the second wall and the sidewall; and the electrode assembly is disposed in the accommodation cavity,
wherein the first wall is provided with an opening, and in the first direction, a projection of the conductive piece is at least partly located in a region of a projection of the opening;
the battery further comprises a sealing structure and an insulation piece, the sealing structure is disposed at an end of the first wall towards the conductive piece, the sealing structure is connected to the first wall, and the insulation piece is disposed between the sealing structure and the conductive piece; and
a thermal expansion coefficient of at least one of the sealing structure or the conductive piece is greater than a thermal expansion coefficient of the insulation piece.

2. The battery according to claim 1, wherein the sealing structure and the first wall are integrated.

3. The battery according to claim 1, wherein the sealing structure comprises a fitting section and a transition section;
the fitting section contacts the insulation piece; and the transition section connects the fitting section and the first wall; and
as viewed along a direction perpendicular to the first direction:
the transition section extends away from the electrode assembly, and the fitting section extends toward the electrode assembly; or the transition section extends toward the electrode assembly, and the fitting section extends away from the electrode assembly.

4. The battery according to claim 3, wherein the transition section comprises:
a first sub-section extending from the first wall and away from the electrode assembly; and
a second sub-section extending from the first sub-section to the insulation piece;
wherein the fitting section is disposed at an end of the second sub-section, the end being towards the insulation piece.

5. The battery according to claim 4, wherein the sealing structure satisfies at least one of the following conditions:
an angle between the first sub-section and the first wall is 85° to 175°;
an angle between the first sub-section and the second sub-section is 85° to 175°; and
an angle between the fitting section and the second sub-section is 80° to 100°.

6. The battery according to claim 4, wherein the second sub-section is in an arc shape protruding from the accommodation cavity.

7. The battery according to claim 4, wherein the second sub-section is wave-shaped when viewed along a direction perpendicular to the first direction.

8. The battery according to claim 4, wherein an inset is disposed in the fitting section, and the inset is inserted into the insulation piece.

9. The battery according to claim 1, wherein when viewed in a direction perpendicular to the first direction, a saw-toothed first connecting portion is disposed on an outer periphery of the conductive piece, and the insulation piece is provided with a second connecting portion in contact with the first connecting portion.

10. The battery according to claim 2, wherein when viewed in a direction perpendicular to the first direction, a saw-toothed third connecting portion is disposed on an outer periphery of the insulation piece, and the fitting section is provided with a fourth connecting portion in contact with the third connecting portion.

11. The battery according to claim 1, wherein a dimension of the sealing structure in the first direction is 10 μm to 1 mm.

12. The battery according to claim 1, wherein a length by which the sealing structure extends from the first wall to the insulation piece is 10 μm to 5 mm.

13. The battery according to claim 1, wherein when viewed in a direction perpendicular to the first direction, a distance from an end of the sealing structure away from the electrode assembly to the electrode assembly is less than a distance from an end of the insulation piece away from the electrode assembly to the electrode assembly.

14. The battery according to claim 1, wherein a thermal expansion coefficient of the insulation piece is —10×10⁻⁶/K to 10×10⁻⁶/K, and a thermal expansion coefficient of the sealing structure is 10×10⁻⁶/K to 40×10⁻⁶/K.

15. The battery according to claim 1, wherein at least one of the sealing structure or the conductive piece comprises a metal material.

16. The battery according to claim 1, wherein the insulation piece comprises at least one of glass, ceramic, or a polymer material.

17. The battery according to claim 1, wherein the electrode assembly comprises a first electrode and a second electrode, the first electrode is electrically connected to the housing, and the second electrode is electrically connected to the conductive piece.

18. An electronic device, comprising a battery, the battery comprises a conductive piece, an electrode assembly and a housing; wherein the housing comprises a first wall, a second wall and a sidewall connected to the first wall and the second wall respectively;
the first wall and the second wall are disposed opposite to each other along a first direction; an accommodation cavity is formed between the first wall, the second wall and the sidewall; and the electrode assembly is disposed in the accommodation cavity,
wherein the first wall is provided with an opening, and in the first direction, a projection of the conductive piece is at least partly located in a region of a projection of the opening;
the battery further comprises a sealing structure and an insulation piece, the sealing structure is disposed at an end of the first wall towards the conductive piece, the sealing structure is connected to the first wall, and the insulation piece is disposed between the sealing structure and the conductive piece; and
a thermal expansion coefficient of at least one of the sealing structure or the conductive piece is greater than a thermal expansion coefficient of the insulation piece.

19. The electronic device according to claim 18, wherein the sealing structure comprises a fitting section and a transition section;
the fitting section contacts the insulation piece; and the transition section connects the fitting section and the first wall; and
as viewed along a direction perpendicular to the first direction:
the transition section extends away from the electrode assembly, and the fitting section extends toward the electrode assembly; or the transition section extends toward the electrode assembly, and the fitting section extends away from the electrode assembly.

20. The electronic device according to claim 18, wherein a thermal expansion coefficient of the insulation piece is —10×10⁻⁶/K to 10×10⁻⁶/K, and a thermal expansion coefficient of the sealing structure is 10×10⁻⁶/K to 40×10⁻⁶/K.
